(19) United States
(12) Patent Application Publication
(10) Pub. No.: US 2022/0269155 A1
(43) Pub. Date: Aug. 25, 2022

(54) WAVELENGTH CONVERSION MODULE AND PROJECTOR

(71) Applicant: Coretronic Corporation, Hsin-Chu (TW)

(72) Inventor: Tsung-Hsiang Fu, Hsin-Chu (TW)

(73) Assignee: Coretronic Corporation, Hsin-Chu (TW)

(21) Appl. No.: 17/672,702

(22) Filed: Feb. 16, 2022

(30) Foreign Application Priority Data
Feb. 22, 2021 (CN) 202110198159.9

(51) Int. Cl. G03B 21/20; B32B 7/12; B32B 3/26

(52) U.S. Cl. CPC G03B 21/204; B32B 7/12; B32B 3/266; B32B 2307/302; B32B 2307/416; B32B 2551/00

(57) ABSTRACT

A wavelength conversion module includes a substrate and a wavelength conversion layer. The substrate has a first surface and a second surface opposite to each other, and at least one through hole penetrating the substrate and connecting the first surface and the second surface. The wavelength conversion layer is disposed on the first surface of the substrate and covers the through hole. The orthographic projection of the wavelength conversion layer on the substrate overlaps the through hole. A projector including the wavelength conversion module is also provided.

### CROSS-REFERENCE TO RELATED APPLICATION

This application claims the priority benefit of China application serial no. 202110198159.9, filed on Feb. 22, 2021. The entirety of the above-mentioned patent application is hereby incorporated by reference herein and made a part of this specification.

### BACKGROUND OF THE DISCLOSURE

### Field of the Disclosure

The disclosure relates to an optical module and a projector, and particularly relates to a wavelength conversion module and a projector having the wavelength conversion module.

### Description of Related Art

In the solid state light source (SSI) projector, the solid state light source is, for example, a laser. The phosphor wheel is disposed on the transmission path of the illumination beam emitted by the solid state light source, and the blue laser light source emits the blue laser light on the light conversion region of the phosphor wheel to excite the yellow beam or other required color light. The existing phosphor layer made of phosphor in ceramic (PIC) or sintered glass material is directly attached to the thermally conductive substrate. The heat dissipation mode of the phosphor wheel performs heat dissipation on the excitation beam incident surface of the phosphor layer through heat conduction of the thermally conductive substrate and the air convection generated when the phosphor wheel rotates. However, an adhesive layer is also provided between the phosphor layer and the thermally conductive substrate, and the thermal conductivity of the adhesive layer is low, which results in poor thermal conductivity of the entire phosphor layer.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the disclosure was acknowledged by a person of ordinary skill in the art.

### SUMMARY OF THE DISCLOSURE

The disclosure provides a wavelength conversion module, which may have a better heat dissipation effect on the wavelength conversion layer.

The disclosure further provides a projector, which includes the above-mentioned wavelength conversion module, which has better projection quality and product competitiveness.

The other objectives and advantages of the disclosure may be further understood from the technical features disclosed in the disclosure.

In order to achieve one or part or all of the above objectives or other objectives, an embodiment of the disclosure provides a wavelength conversion module including a substrate and a wavelength conversion layer. The substrate has a first surface and a second surface opposite to each other, and at least one through hole penetrating the substrate and connecting the first surface and the second surface. The wavelength conversion layer is disposed on the first surface of the substrate and covers the through hole. The orthographic projection of the wavelength conversion layer on the substrate overlaps the through hole.

In order to achieve one or part or all of the above objectives or other objectives, an embodiment of the disclosure provides a projector including a light-emitting unit, a wavelength conversion module, a light valve, and a projection lens. The light-emitting unit is configured to emit an illumination beam. The wavelength conversion module is disposed on the transmission path of the illumination beam. The wavelength conversion module includes a substrate and a wavelength conversion layer. The substrate has a first surface and a second surface opposite to each other, and at least one through hole penetrating the substrate and connecting the first surface and the second surface. The wavelength conversion layer is disposed on the first surface of the substrate and covers the through hole. The orthographic projection of the wavelength conversion layer on the substrate overlaps the through hole. The light valve is disposed on the transmission path of the illumination beam and is configured to convert the illumination beam into an image beam. The projection lens is disposed on the transmission path of the image beam and configured to convert the image beam into a projection beam.

Based on the above, the embodiments of the disclosure at least have one of the following advantages or effects. In the design of the wavelength conversion module of the disclosure, since the orthographic projection of the wavelength conversion layer on the substrate overlaps the through holes of the substrate, when the wavelength conversion module is in operation, the gas may form forced convection or natural convection in the through holes of the substrate, so that the circular airflow can directly blow the wavelength conversion layer, which facilitates the heat dissipation of the wavelength conversion layer. In short, the wavelength conversion module of the disclosure may have a better heat dissipation effect on the wavelength conversion layer, and the wavelength conversion module of the disclosure may have better projection quality and product competitiveness.

Other objectives, features and advantages of the present disclosure will be further understood from the further technological features disclosed by the embodiments of the present disclosure wherein there are shown and described preferred embodiments of this disclosure, simply by way of illustration of modes best suited to carry out the disclosure.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1A is a schematic diagram of a projector according to an embodiment of the disclosure.

FIG. 1B is a schematic side view of the wavelength conversion module of the projector shown in FIG. 1A.

FIG. 2 to FIG. 16 are schematic side views of various wavelength conversion modules according to various embodiments of the disclosure.

FIG. 17A is a schematic front view of a wavelength conversion module according to an embodiment of the disclosure.

FIG. 17B is a schematic back view of the wavelength conversion module of FIG. 17A.

FIG. 18 to FIG. 31 are schematic back views of various wavelength conversion modules according to various embodiments of the disclosure.

### DESCRIPTION OF EMBODIMENTS

In the following detailed description of the preferred embodiments, reference is made to the accompanying drawings which form a part hereof, and in which are shown by way of illustration specific embodiments in which the disclosure may be practiced. In this regard, directional terminology, such as “top,” “bottom,” “front,” “back,” etc., is used with reference to the orientation of the Figure(s) being described. The components of the present disclosure can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present disclosure. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

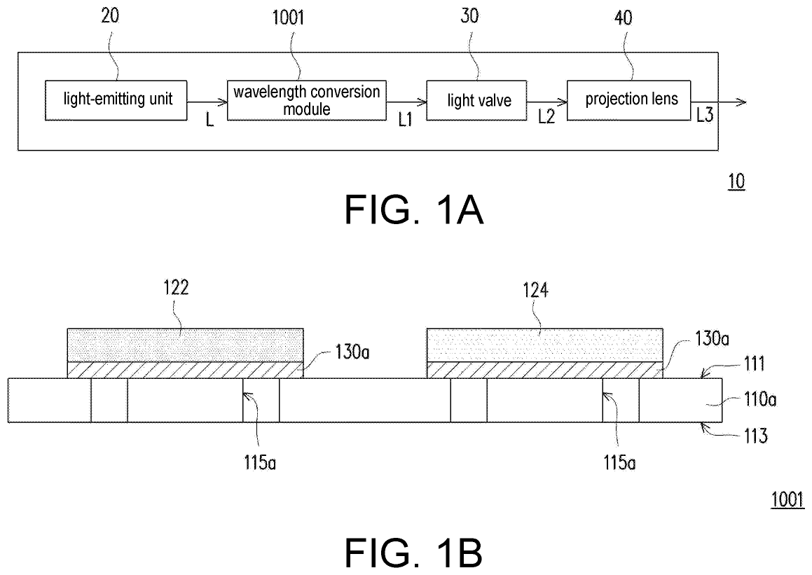

FIG. 1A is a schematic diagram of a projector according to an embodiment of the disclosure. FIG. 1B is a schematic side view of the wavelength conversion module of the projector shown in FIG. 1A. Please refer to FIG. 1A. In this embodiment, the projector 10 includes a light-emitting unit 20, a wavelength conversion module 1001, a light valve 30, and a projection lens 40. The light-emitting unit 20 is configured to emit the excitation beam L, and after being converted by the wavelength conversion module 1001 and the light valve 30, a projection beam L3 is projected to a display screen (not shown) outside the projector 10 through the projection lens 40. Here, the light-emitting unit 20 is, for example, a light-emitting diode or a laser diode. Preferably, the light-emitting unit 20 is a blue light-emitting diode, but it is not limited thereto.

The wavelength conversion module 1001 is, for example, a phosphor wheel for receiving the excitation beam L, wherein the wavelength conversion module 1001 is located on a transmission path of the excitation beam L, and the wavelength conversion module 1001 may convert the optical wavelength of the excitation beam L to form a wavelength conversion beam, and the excitation beam L and the wavelength conversion beam are formed into an illumination beam L1 according to time sequence. The light valve 30 is disposed on a transmission path of the illumination beam L1, and is configured to convert the illumination beam L1 into an image beam L2. The projection lens 40 is disposed on a transmission path of the image beam L2, and is configured to convert the image beam L2 into the projection beam L3.

Furthermore, the light valve 30 adopted in this embodiment is, for example, a reflective light modulator such as a liquid crystal on silicon panel (LCoS panel), a digital micro-mirror device (DMD), etc. In an embodiment, the light valve 30 is, for example, a transmissive optical modulator such as a transparent liquid crystal panel, an electro-optical modulator, a maganeto-optic modulator, and an acousto-optic modulator (AOM), etc., but this embodiment has no limitation to the form and type of the light valve 30. The detailed steps and implementation of the method for the light valve 30 to modulate the illumination beam L1 into the image beam L2 may be obtained from general knowledge in the technical field with sufficient teachings, suggestions and implementation descriptions, and therefore no further description is incorporated herein. In addition, the projection lens 40 includes, for example, a combination of one or more optical lenses with refractive power, such as various combinations of non-planar lenses such as biconcave lenses, biconvex lenses, meniscus lenses, convex-concave lenses, plano-convex lenses, and plano-concave lenses. In an embodiment, the projection lens 40 may also include a planar optical lens to convert the image beam from the light valve 30 into a projection beam and project the projection beam out of the projector 10 by means of reflection or penetration. Herein, this embodiment has no limitation to the form and type of the projection lens 40.

Next, referring to FIG. 1B, in this embodiment, the wavelength conversion module 1001 includes a substrate 110a and a wavelength conversion layer (two wavelength conversion layers 122 and 124 are shown schematically) for receiving the excitation beam L from the light-emitting unit 20. The substrate 110a has a first surface 111 and a second surface 113 opposite to each other, and at least one through hole (a plurality of through holes 115a are schematically shown) penetrating the substrate 110a and connecting the first surface 111 and the second surface 113. The wavelength conversion layers 122 and 124 are disposed on the first surface 111 of the substrate 110a and cover the through holes 115a. The orthographic projections of the wavelength conversion layers 122 and 124 on the substrate 110a overlap the through holes 115a. As shown in FIG. 1B, the orthographic projections of the wavelength conversion layers 122 and 124 on the substrate 110a completely overlap the through holes 115a. Here, the substrate 110a is embodied as a thermally conductive substrate, and material of the substrate 110a may include metal or ceramic.

Furthermore, the wavelength conversion module 1001 of this embodiment further includes a reflective layer 130a, which is disposed between the first surface 111 of the substrate 110a and the wavelength conversion layers 122 and 124. The orthographic projections of the wavelength conversion layers 122 and 124 on the substrate 110a completely overlap the orthographic projection of the reflective layer 130a on the substrate 110a. Preferably, the orthographic projection areas of the wavelength conversion layers 122 and 124 on the substrate 110a are equal to the orthographic projection area of the reflective layer 130a on the substrate 110a. The substrate 110a and the reflective layer 130a may be sintered integrally.

Since the orthographic projections of the wavelength conversion layers 122 and 124 on the substrate 110a overlap the through holes 115a on the substrate 110a, when the wavelength conversion module 1001 is in operation, the gas may form forced convection or natural convection in the through holes 115a of the substrate 110a, so that the circular airflow may be directly blown to the reflective layer 130a and the wavelength conversion layers 122 and 124, which facilitates the heat dissipation of the wavelength conversion layers 122 and 124. That is to say, the wavelength conversion layers 122 and 124 of this embodiment have an additional heat dissipation path, which means that other than the heat conduction of the original substrate 110a and the heat convection on the excitation beam incident surface of the wavelength conversion layers 122 and 124, the arrangement of the through holes 115a may also cause the gas to generate heat convection on the rear surface of the wavelength conversion layers 122 and 124 relative to the excitation beam incident surface. In short, the wavelength conversion module 1001 of this embodiment may have better heat dissipation effects on the wavelength conversion layers 122 and 124, and a better projection quality and product competitiveness may be achieved by adopting the wavelength conversion module 1001 in this embodiment. Furthermore, the arrangement of the through holes 115a of this embodiment may also reduce the initial imbalance, and thus decreasing the amount of attached or filled substances for balancing. In addition, the arrangement of the through holes 115a in this embodiment may also reduce the weight of the substrate 110a, so as to reduce the load of motor.

It should be noted here that the following embodiments adopt the reference numbers and part of the content of the foregoing embodiments, wherein the same reference numbers are used to represent the same or similar elements, and the description of the same technical content is omitted. For the description of the omitted parts, reference may be made to the foregoing embodiments, and no further description will be incorporated in the following embodiments.

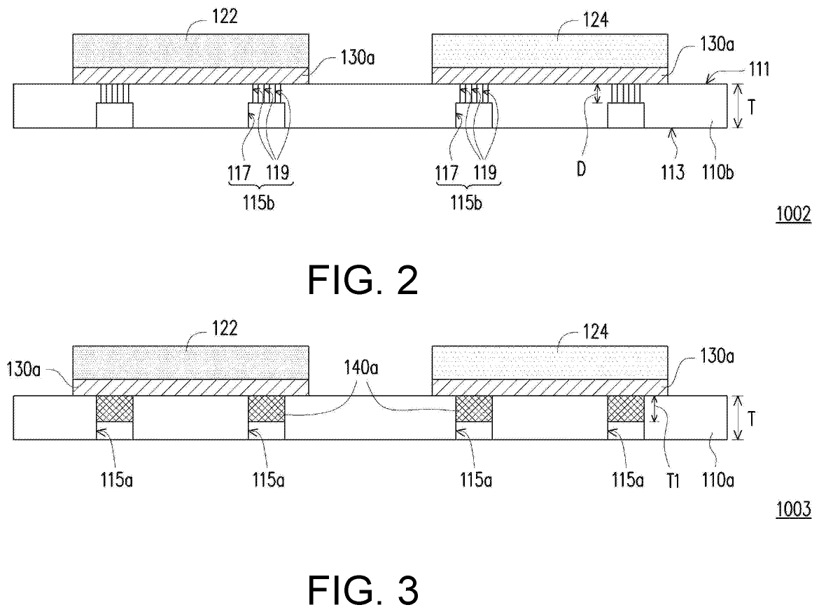

FIG. 2 is a schematic side view of a wavelength conversion module according to an embodiment of the disclosure. Please refer to FIG. 1B and FIG. 2 at the same time. The wavelength conversion module 1002 of this embodiment is similar to the wavelength conversion module 1001 of FIG. 1B. The difference between the two is: in this embodiment, the through hole 115b of the substrate 110b includes at least one blind via (a plurality of blind vias 117 are shown schematically) and a plurality of micropores 119. The blind vias 117 extend from the second surface 113 to the direction of the first surface 111. The micropores 119 extend from the first surface 111 to the direction of the second surface 113 and correspond to the positions of the blind vias 117, but the micropores 119 do not communicate with the blind vias 117. The depth D of the micropores 119 accounts for at least 30% of the thickness T of the substrate 110b. Here, the aperture of the blind vias 117 is greater than the aperture of the micropores 119, wherein the aperture of the blind vias 117 is between 1.2 mm and 2 mm, and the aperture of the micropores 119 is between 0.3 mm and 0.7 mm.

FIG. 3 is a schematic side view of a wavelength conversion module according to another embodiment of the disclosure. Please refer to FIG. 1B and FIG. 3 at the same time. The wavelength conversion module 1003 of this embodiment is similar to the wavelength conversion module 1001 of FIG. 1B. The difference between the two is: in this embodiment, the wavelength conversion module 1003 further includes a thermally conductive material 140a filled in the through hole 115a. The thermally conductive material 140a directly contacts the reflective layer 130a, wherein the thermal conductivity of the thermally conductive material 140a is greater than the thermal conductivity of the substrate 110a. Here, the thermal conductivity of the thermally conductive material 140a is between 200 W/mk and 5000 W/mk, wherein the thermally conductive material 140a is, for example, graphene, diamond, silver, copper, aluminum, gold, silicon carbide, or a combination of the foregoing materials. After the through hole 115a is formed in the substrate 110a, the thermally conductive material 140a with higher thermal conductivity may be filled in. In addition to reducing the production cost (as compared to using a whole thermally conductive material as the substrate), the above approach may also take into account the thermal conductivity of the substrate 110a, and through the heat convection at the through hole 115a, the heat dissipation effect of the heat convection may be increased. Preferably, the thickness T1 of the thermally conductive material 140a at least accounts for 20% of the thickness T of the substrate 110a.

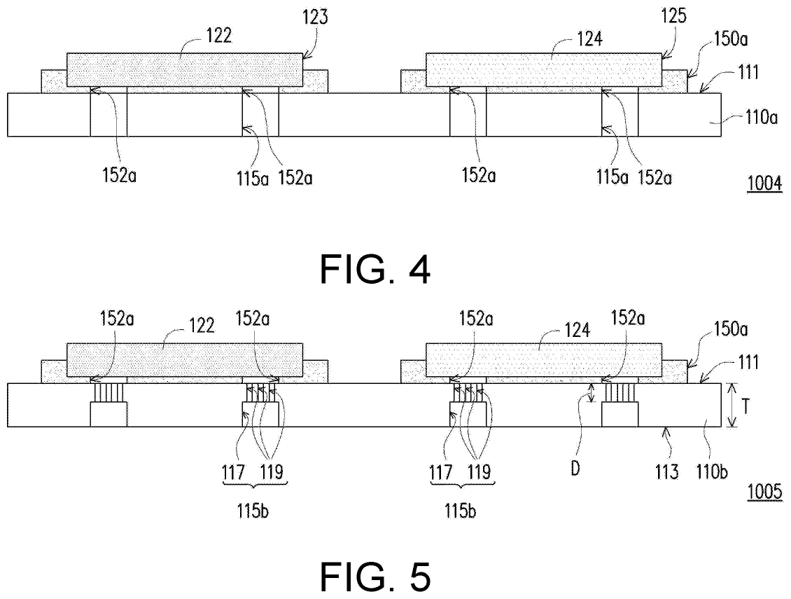

FIG. 4 is a schematic side view of a wavelength conversion module according to another embodiment of the disclosure. Please refer to FIG. 1B and FIG. 4 at the same time. The wavelength conversion module 1004 of this embodiment is similar to the wavelength conversion module 1001 of FIG. 1B. The difference between the two is: the wavelength conversion module 1004 of this embodiment is not provided with the reflective layer 130a as shown in FIG. 1B. In details, the wavelength conversion module 1004 of this embodiment further includes an adhesive layer 150a, which is disposed between the first surface 111 of the substrate 110a and the wavelength conversion layers 122 and 124, and extends to cover peripheral surfaces 123 and 125 of the wavelength conversion layers 122 and 124, so that the wavelength conversion layers 122 and 124 may be stably disposed on the first surface 111 of the substrate 110a through the adhesive layer 150a. The adhesive layer 150a has at least one opening (a plurality of openings 152a are shown schematically), and the opening 152a is connected to the through hole 115a. Therefore, when the wavelength conversion module 1004 is in operation, the through hole 115a of the substrate 110a may form forced convection or natural convection, so that the circulating airflow may directly blow the wavelength conversion layers 122 and 124, which facilitates the heat dissipation of the wavelength conversion layers 122 and 124.

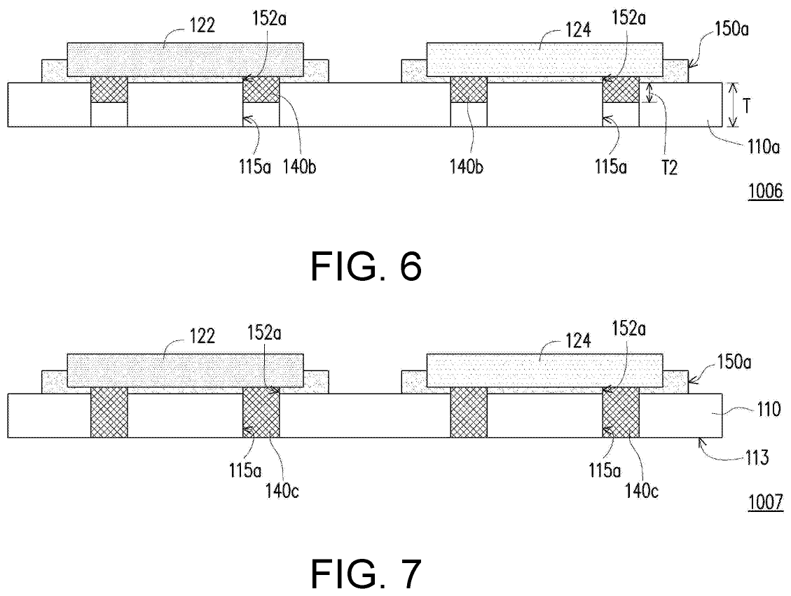

FIG. 5 is a schematic side view of a wavelength conversion module according to another embodiment of the disclosure. Please refer to FIG. 4 and FIG. 5 at the same time, the wavelength conversion module 1005 of this embodiment is similar to the wavelength conversion module 1004 of FIG. 4, and the difference between the two is: in this embodiment, the through hole 115b of the substrate 110b includes at least one blind via (a plurality of blind vias 117 are shown schematically) and a plurality of micropores 119. The blind vias 117 extend from the second surface 113 to the direction of the first surface 111. The micropores 119 extend from the first surface 111 to the direction of the second surface 113. The depth D of the micropores 119 at least accounts for 30% of the thickness T of the substrate 110b. Here, the aperture of the blind vias 117 is greater than the aperture of the micropores 119, wherein the aperture of the blind vias 117 is between 1.2 mm and 2 mm, and the aperture of the micropores 119 is between 0.3 mm and 0.7 mm. FIG. 6 is a schematic side view of a wavelength conversion module according to still another embodiment of the disclosure. Referring to FIG. 4 and FIG. 6 at the same time, the wavelength conversion module 1006 of this embodiment is similar to the wavelength conversion module 1004 of FIG. 4, and the difference between the two is: in this embodiment, the wavelength conversion module 1006 further includes a thermally conductive material 140b which is filled up in the opening 152a of the adhesive layer 150a and is filled in the through hole 115a. The thermally conductive material 140b directly contacts the wavelength conversion layers 122 and 124, and the thermal conductivity of the thermally conductive material 140b is greater than the thermal conductivity of the substrate 110a. Here, the thermal conductivity of the thermally conductive material 140b is between 200 W/mk and 5000 W/mk, wherein the thermally conductive material 140b is, for example, graphene, diamond, silver, copper, aluminum, gold, silicon carbide, or a combination of the foregoing materials. After the through hole 115a is formed on the substrate 110a, the thermally conductive material 140b with higher thermal conductivity is filled in. Other than reducing the production cost (as compared to using a whole thermally conductive material as the substrate), the above approach may further take into account the thermal conductivity of the substrate 110a, and through the heat convection at the through hole 115a, the heat dissipation effect of the heat convection may be increased. Preferably, the thickness T2 of the thermally conductive material 140b in the through hole 115a at least accounts for 20% of the thickness T of the substrate 110a.

FIG. 7 is a schematic side view of a wavelength conversion module according to still another embodiment of the disclosure. Referring to FIG. 6 and FIG. 7 at the same time, the wavelength conversion module 1007 of this embodiment is similar to the wavelength conversion module 1006 of FIG. 6, the difference between the two is: in this embodiment, the thermally conductive material 140c is filled up in the through hole 115a, and the thermally conductive material 140c is aligned with the second surface 113 of the substrate 110a. In short, the thermally conductive materials 140a, 140b, and 140c may account for between 20% and 100% of the thickness of the substrate 110a.

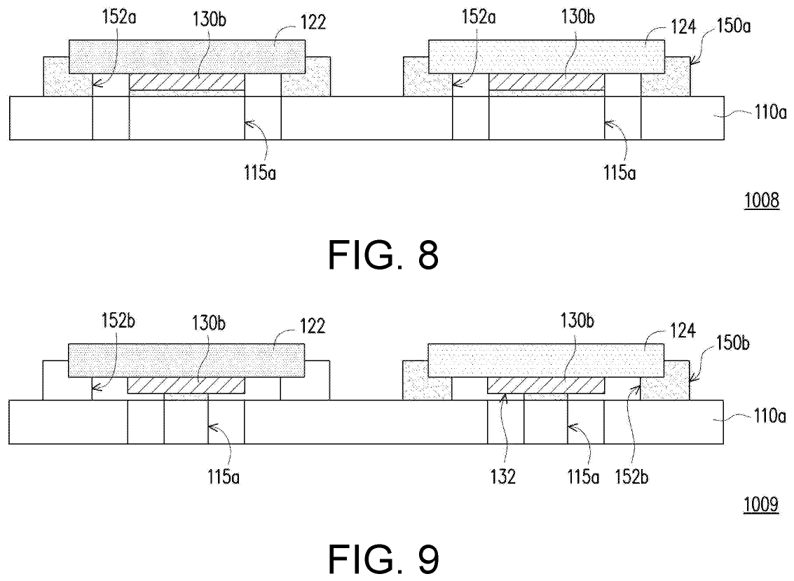

FIG. 8 is a schematic side view of a wavelength conversion module according to still another embodiment of the disclosure. Referring to FIG. 4 and FIG. 8 at the same time, the wavelength conversion module 1008 of this embodiment is similar to the wavelength conversion module 1004 of FIG. 4, and the difference between the two is: in this embodiment, the wavelength conversion module 1008 further includes a reflective layer 130b disposed between the wavelength conversion layers 122 and 124 and a part of the adhesive layer 150a. The orthographic projections of the wavelength conversion layers 122 and 124 on the substrate 110a completely overlap the orthographic projection of the reflective layer 130b on the substrate 110a. Preferably, the orthographic projection areas of the wavelength conversion layers 122 and 124 on the substrate 110a are greater than the orthographic projection area of the reflective layer 130b on the substrate 110a. In other words, the edge of the reflective layer 130b here is not aligned with the edges of the wavelength conversion layers 122 and 124.

FIG. 9 is a schematic side view of a wavelength conversion module according to still another embodiment of the disclosure. Please refer to FIG. 8 and FIG. 9 at the same time. The wavelength conversion module 1009 of this embodiment is similar to the wavelength conversion module 1008 of FIG. 8. The difference between the two is: in this embodiment, the opening 152b of the adhesive layer 150b exposes a surface 132 of the reflective layer 130b relatively far away from the wavelength conversion layers 122 and 124.

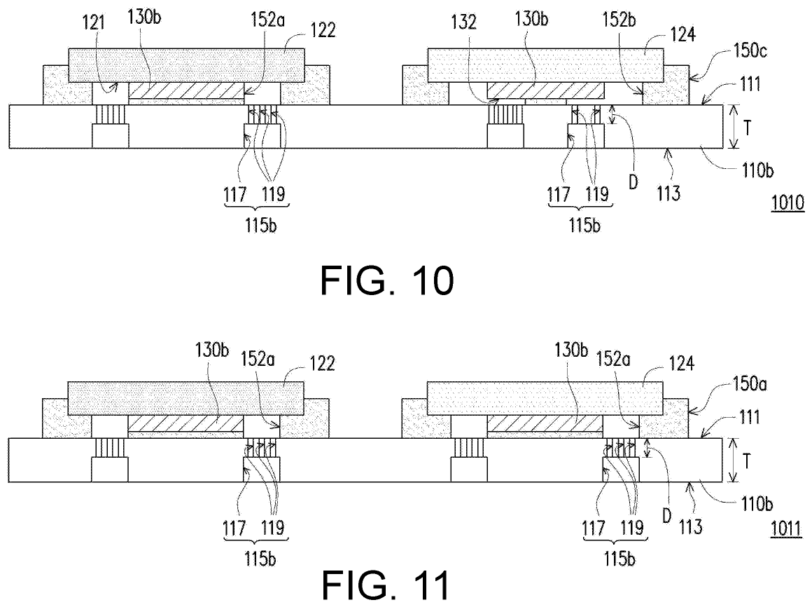

FIG. 10 is a schematic side view of a wavelength conversion module according to still another embodiment of the disclosure. Referring to FIG. 9 and FIG. 10 at the same time, the wavelength conversion module 1010 of this embodiment is similar to the wavelength conversion module 1009 of FIG. 9, and the difference between the two is: in this embodiment, the opening 152a of the adhesive layer 150c exposes the lower surface 121 of the wavelength conversion layer 122, and the opening 152b of the adhesive layer 150c exposes the surface 132 of the reflective layer 130b relatively far away from the wavelength conversion layers 122 and 124. In addition, the through hole 115b of the substrate 110b of the embodiment includes at least one blind via (a plurality of blind vias 117 are shown schematically) and a plurality of micropores 119. The blind vias 117 extend from the second surface 113 to the direction of the first surface 111. The micropores 119 extend from the first surface 111 to the direction the second surface 113 and are connected to the blind vias 117. The depth D of the micropores 119 at least accounts for 30% of the thickness T of the substrate 110b. Here, the aperture of the blind vias 117 is greater than the aperture of the micropores 119, wherein the aperture of the blind vias 117 is between 1.2 mm and 2 mm, and the aperture of the micropores 119 is between 0.3 mm and 0.7 mm.

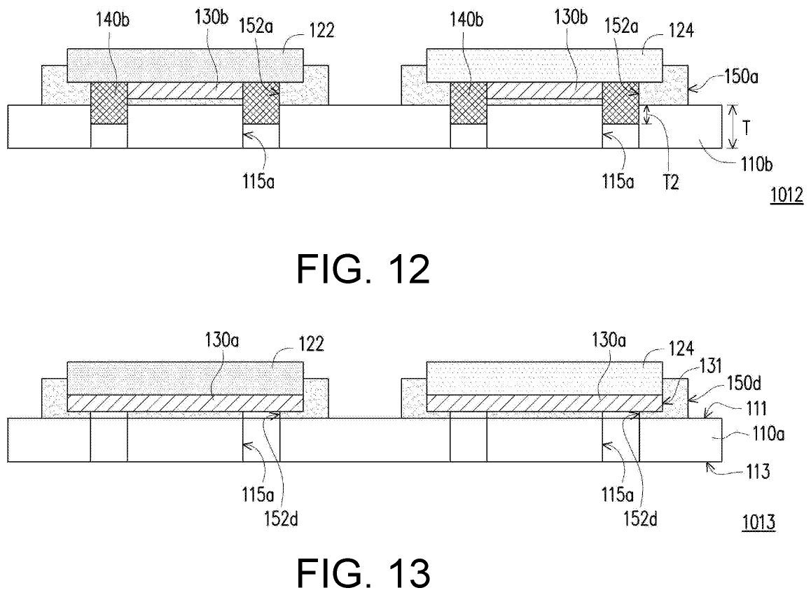

FIG. 11 is a schematic side view of a wavelength conversion module according to still another embodiment of the disclosure. Please refer to FIG. 8 and FIG. 11 at the same time. The wavelength conversion module 1011 of this embodiment is similar to the wavelength conversion module 1008 of FIG. 8. The difference between the two is: the through hole 115b of the substrate 110b of the embodiment includes at least one blind via (a plurality of blind vias 117 are shown schematically) and a plurality of micropores 119. The blind vias 117 extend from the second surface 113 to the direction of the first surface 111. The micropores 119 extend from the first surface 111 to the direction of the second surface 113. The depth D of the micropores 119 at least accounts for 30% of the thickness T of the substrate 110b. Here, the aperture of the blind vias 117 is greater than the aperture of the micropores 119, wherein the aperture of the blind vias 117 is between 1.2 mm and 2 mm, and the aperture of the micropores 119 is between 0.3 mm and 0.7 mm.

FIG. 12 is a schematic side view of a wavelength conversion module according to still another embodiment of the disclosure. Please refer to FIG. 8 and FIG. 12 at the same time. The wavelength conversion module 1012 of this embodiment is similar to the wavelength conversion module 1008 of FIG. 8. The difference between the two is: in this embodiment, the wavelength conversion module 1012 further includes a thermally conductive material 140b which is filled up in the opening 152a of the adhesive layer 150a and is filled in the through hole 115a. The thermally conductive material 140b directly contacts the wavelength conversion layers 122 and 124, and the thermal conductivity of the thermally conductive material 140b is greater than the thermal conductivity of the substrate 110a. Here, the thermal conductivity of the thermally conductive material 140b is between 200 W/mk and 5000 W/mk, wherein the thermally conductive material 140b is, for example, graphene, diamond, silver, copper, aluminum, gold, silicon carbide, or a combination of the foregoing materials. After the through hole 115a is formed on the substrate 110a, the thermally conductive material 140b with higher thermal conductivity is filled in. Other than reducing the production cost (as compared to using a whole thermally conductive material as the substrate), the above approach can further take into account the thermal conductivity of the substrate 110a, and through the heat convection at the through hole 115a, the heat dissipation effect of the heat convection may be increased. Preferably, the thickness T2 of the thermally conductive material 140b in the through hole 115a at least accounts for 20% of the thickness T of the substrate 110a.

FIG. 13 is a schematic side view of a wavelength conversion module according to still another embodiment of the disclosure. Please refer to FIG. 1B and FIG. 13 at the same time. The wavelength conversion module 1013 of this embodiment is similar to the wavelength conversion module 1001 of FIG. 1B. The difference between the two is: in this embodiment, the wavelength conversion module 1013 further includes an adhesive layer 150d which is disposed between the first surface 111 of the substrate 110a and the reflective layer 130a, and extends to cover a peripheral surface 131 of the reflective layer 130a. The adhesive layer 150d has at least one opening (a plurality of openings 152d are shown schematically), and the opening 152d communicates with the through hole 115a. Here, the orthographic projections of the wavelength conversion layers 122 and 124 on the substrate 110a completely overlap the orthographic projection of the reflective layer 130a on the substrate 110a. Preferably, the orthographic projection areas of the wavelength conversion layers 122 and 124 on the substrate 110a are equal to the orthographic projection area of the reflective layer 130a on the substrate 110a.

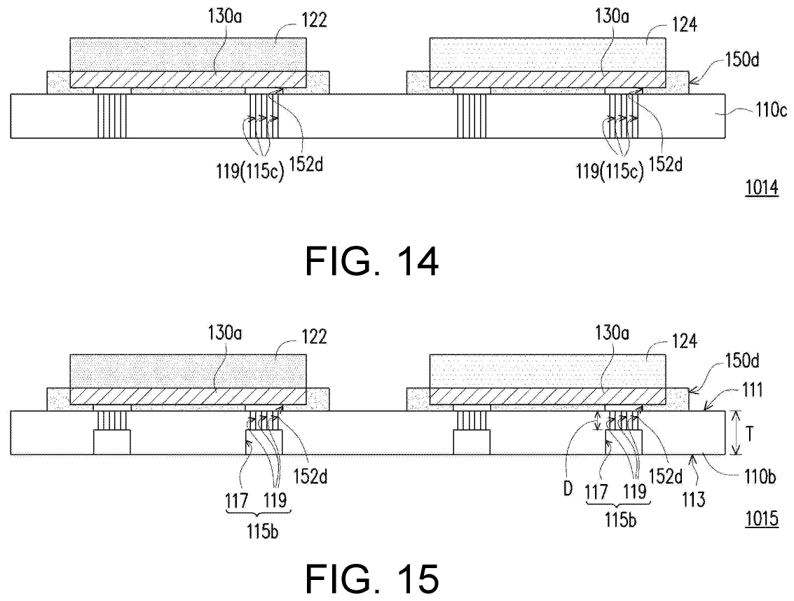

FIG. 14 is a schematic side view of a wavelength conversion module according to still another embodiment of the disclosure. Referring to FIG. 13 and FIG. 14 at the same time, the wavelength conversion module 1014 of this embodiment is similar to the wavelength conversion module 1013 of FIG. 13. The difference between the two is: in this embodiment, the through hole 115c of the substrate 110c is embodied as the micropore 119, wherein the aperture of the micropore 119 is between 0.3 mm and 0.7 mm.

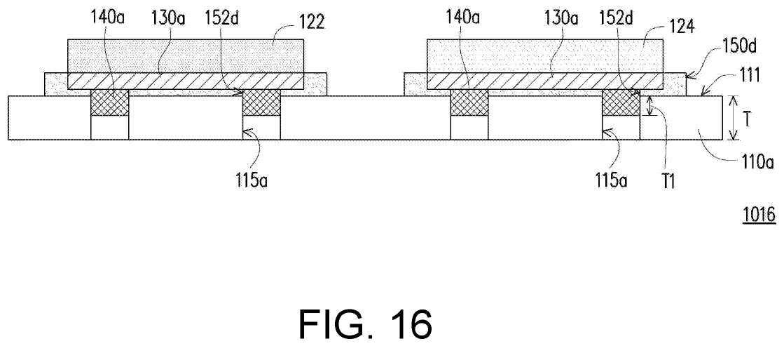

FIG. 15 is a schematic side view of a wavelength conversion module according to another embodiment of the disclosure. Referring to FIG. 13 and FIG. 15 at the same time, the wavelength conversion module 1015 of this embodiment is similar to the wavelength conversion module 1013 of FIG. 13. The difference between the two is: in this embodiment, the through hole 115b of the substrate 110b includes at least one blind via (a plurality of blind vias 117 are shown schematically) and a plurality of micropores 119. The blind vias 117 extend from the second surface 113 to the direction of the first surface 111. The micropores 119 extend from the first surface 111 to the direction of the second surface 113. The depth D of the micropores 119 at least accounts for 30% of the thickness T of the substrate 110b. Here, the aperture of the blind vias 117 is greater than the aperture of the micropores 119, wherein the aperture of the blind vias 117 is between 1.2 mm and 2 mm, and the aperture of the micropores 119 is between 0.3 mm and 0.7 mm. FIG. 16 is a schematic side view of a wavelength conversion module according to still another embodiment of the disclosure. Referring to FIG. 13 and FIG. 16 at the same time, the wavelength conversion module 1016 of this embodiment is similar to the wavelength conversion module 1013 of FIG. 13. The difference between the two is: the wavelength conversion module 1016 of this embodiment further includes a thermally conductive material 140a which is filled up in the opening 152d of the adhesive layer 150d and is filled in the through hole 115a. The thermally conductive material 140a directly contacts the reflective layer 130a, and the thermal conductivity of the thermally conductive material 140a is greater than the thermal conductivity of the substrate 110a. Here, the thermal conductivity of the thermally conductive material 140a is between 200 W/mk and 5000 W/mk, wherein the thermally conductive material 140a is, for example, graphene, diamond, silver, copper, aluminum, gold, silicon carbide, or a combination of the foregoing materials. After the through hole 115a is formed on the substrate 110a, the thermally conductive material 140a with higher thermal conductivity is filled in. Other than reducing the production cost (as compared to using a whole thermally conductive material as the substrate), the approach may further take into account the thermal conductivity of the substrate 110a, and through the heat convection at the through hole 115a, the heat dissipation effect of the heat convection may be increased. Preferably, the thickness T1 of the thermally conductive material 140a in the through hole 115a at least accounts for 20% of the thickness T of the substrate 110a.

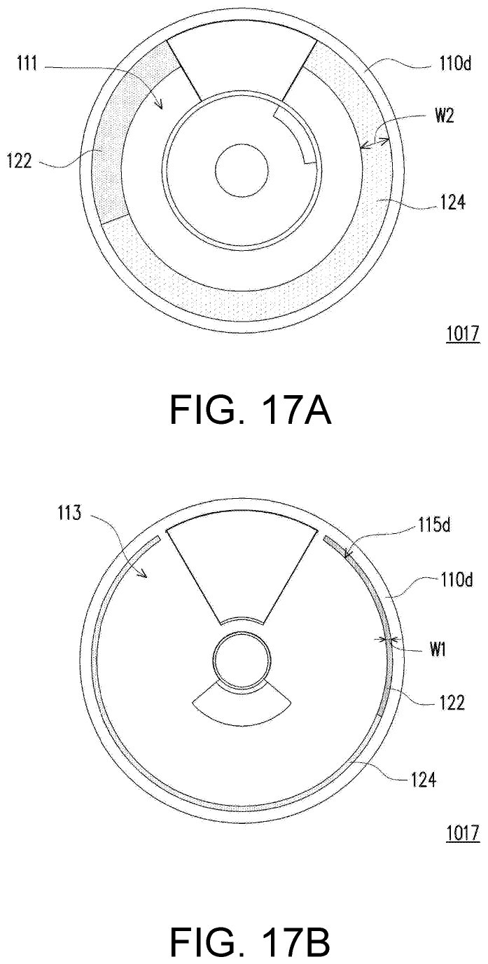

FIG. 17A is a schematic front view of a wavelength conversion module according to an embodiment of the disclosure. FIG. 17B is a schematic back view of the wavelength conversion module of FIG. 17A. Please refer to FIG. 17A and FIG. 17B at the same time. In this embodiment, the wavelength conversion module 1017 includes a substrate 110d and wavelength conversion layers 122 and 124. As shown in FIG. 17B, the substrate 110d has a first surface 111 and a second surface 113 opposite to each other, and a through hole 115d penetrating the substrate 110d and connecting the first surface 111 and the second surface 113. The wavelength conversion layers 122 and 124 are disposed on the first surface 111 of the substrate 110d and cover the through hole 115d. The orthographic projections of the wavelength conversion layers 122 and 124 on the substrate 110d overlap the through hole 115d. Here, the number of the through hole 115d of the substrate 110d is embodied as one, and the shape of the through hole 115d is, for example, an arc shape, but is not limited to thereto. As shown in FIG. 17B, the shape of the through hole 115d is embodied as an outer arc-shaped hole along the outer side of the wavelength conversion layers 122 and 124 (that is, relatively close to the edge of the substrate 110d). Preferably, the orthographic projection area of the through hole 115d on the wavelength conversion layers 122 and 124 accounts for 2% to 20% of the areas of the wavelength conversion layers 122 and 124. A maximum width W1 of the through hole 115d is smaller than a radial width W2 of the wavelength conversion layers 122 and 124, and the maximum width W1 is between 0.1 mm and 5.5 mm.

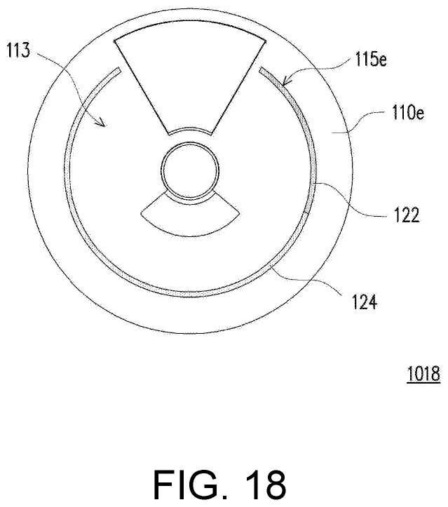

FIG. 18 is a schematic back view of a wavelength conversion module according to an embodiment of the disclosure. Please refer to FIG. 17B and FIG. 18 at the same time. The wavelength conversion module 1018 of this embodiment is similar to the wavelength conversion module 1017 of FIG. 17B. The difference between the two is that the shape of the through hole 115e of the substrate 110e of this embodiment is embodied as an inner arc-shaped hole along the inner side of the wavelength conversion layers 122 and 124 (that is, relatively far away from the edge of the substrate 110e).

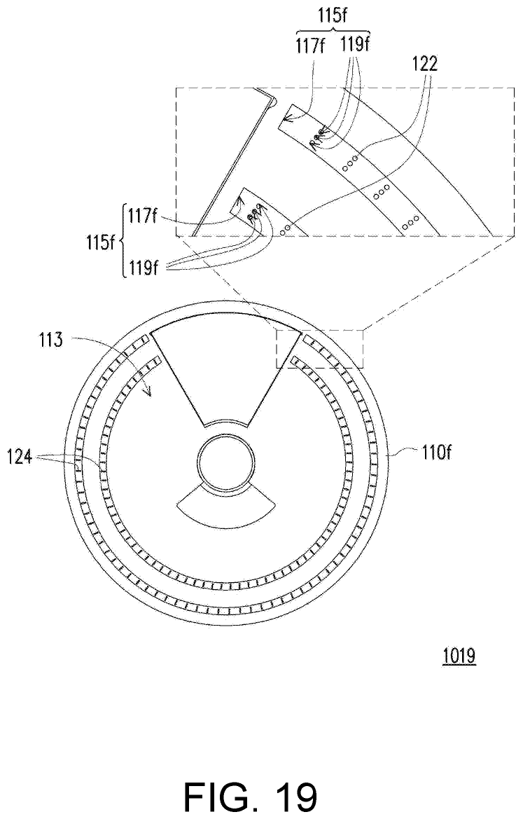

FIG. 19 is a schematic back view of a wavelength conversion module according to an embodiment of the disclosure. Please refer to FIG. 17B and FIG. 19 at the same time. The wavelength conversion module 1019 of this embodiment is similar to the wavelength conversion module 1017 of FIG. 17B. The difference between the two is: in this embodiment, the number of through holes 115f of the substrate 110f is multiple, and the through holes 115f include at least one blind via (two blind vias 117f are shown schematically) and a plurality of micropores 119f, wherein the blind vias 117f are respectively arranged along the inner and outer sides of the wavelength conversion layers 122 and 124, and every three micropores 119f are arranged along the radial direction, but it is not limited thereto. The arrangement of the blind vias 117f and the micropores 119f of the substrate 110f is the same as the arrangement of the blind vias 117 and the micropores 119 of the substrate 110b in FIG. 5. Here, the shape of the blind vias 117f is an arc shape, and the shape of the micropores 119f is a circle, but they are not limited thereto. As shown in FIG. 19, the aperture of the blind vias 117f is greater than the aperture of the micropores 119f, wherein the aperture of the blind vias 117f is between 1.2 mm and 2 mm, and the aperture of the micropores 119f is between 0.3 mm and 0.7 mm.

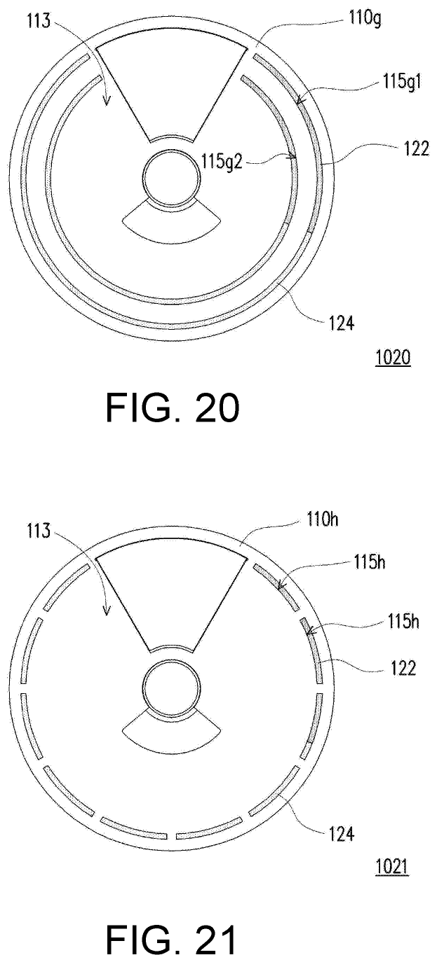

FIG. 20 is a schematic back view of a wavelength conversion module according to an embodiment of the disclosure. Please refer to FIG. 17B and FIG. 20 at the same time. The wavelength conversion module 1020 of this embodiment is similar to the wavelength conversion module 1017 of FIG. 17B. The difference between the two is: in this embodiment, the substrate 110g has two through holes 115g1 and 115g2, meaning that the number of through holes is multiple, and the shape of each through hole 115g1 and 115g2 is embodied as an arc shape. The through hole 115g1 is configured as an outer arc-shaped hole along the outer side of the wavelength conversion layers 122 and 124 (that is, relatively close to the edge of the substrate 110g), and the through holes 115g2 are arranged as inner arc-shaped holes along the inner side of the wavelength conversion layers 122 and 124 (that is, relatively far away from the edge of the substrate 110g).

FIG. 21 is a schematic back view of a wavelength conversion module according to an embodiment of the disclosure. Please refer to FIG. 17B and FIG. 21 at the same time. The wavelength conversion module 1021 of this embodiment is similar to the wavelength conversion module 1017 of FIG. 17B. The difference between the two is: the number of through holes 115h of the substrate 110h of this embodiment is multiple, and the shape of each through hole 115h is embodied as an arc shape, wherein the through holes 115h are separated from each other, and are arranged as non-continuous outer arc-shaped holes along the outer side of the wavelength conversion layers 122 and 124 (that is, relatively close to the edge of the substrate 110h).

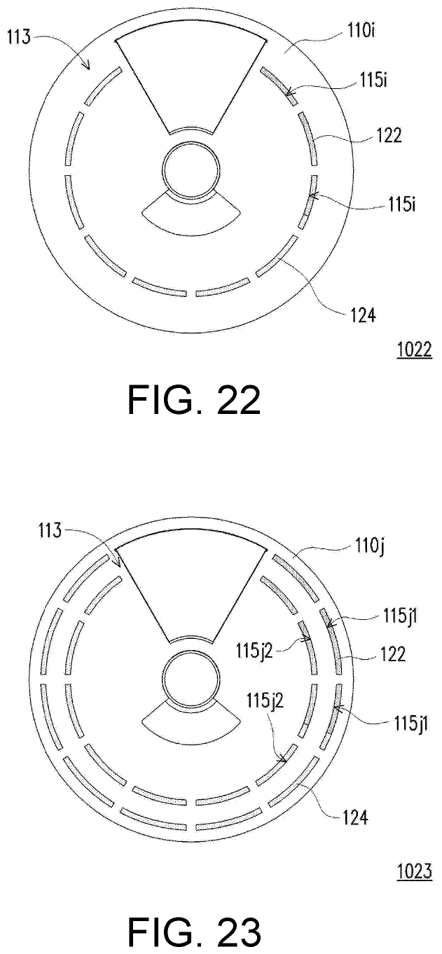

of the ref a schematic back view of a wavelength conversion module according to an embodiment of the disclosure. Please refer to FIG. 17B and FIG. 22 at the same time. The wavelength conversion module 1022 of this embodiment is similar to the wavelength conversion module 1017 of FIG. 17B. The difference between the two is: the number of through holes 115i of the substrate 110i of this embodiment is multiple, and the shape of each through hole 115i is embodied as an arc shape, wherein the through holes 115i are separated from each other, and are arranged as non-continuous inner arc-shaped holes along the inner side of the wavelength conversion layers 122 and 124 (that is, relatively far away from the edge of the substrate 110i).

FIG. 23 is a schematic back view of a wavelength conversion module according to an embodiment of the disclosure. Please refer to FIG. 17B and FIG. 23 at the same time. The wavelength conversion module 1023 of this embodiment is similar to the wavelength conversion module 1017 of FIG. 17B. The difference between the two is: the substrate 110j of this embodiment has a plurality of through holes 115j1 and 115j2, and the shape of each through hole 115j1 and 115j2 is embodied as an arc shape. These through holes 115j1 are separated from each other, and are arranged as non-continuous outer arc-shaped holes along the outer side of the wavelength conversion layers 122 and 124 (that is, relatively close to the edge of the substrate 110j). These through holes 115j2 are separated from each other, and are arranged as non-continuous inner arc-shaped holes along the inner side of the wavelength conversion layers 122 and 124 (that is, relatively far away from the edge of the substrate 110j).

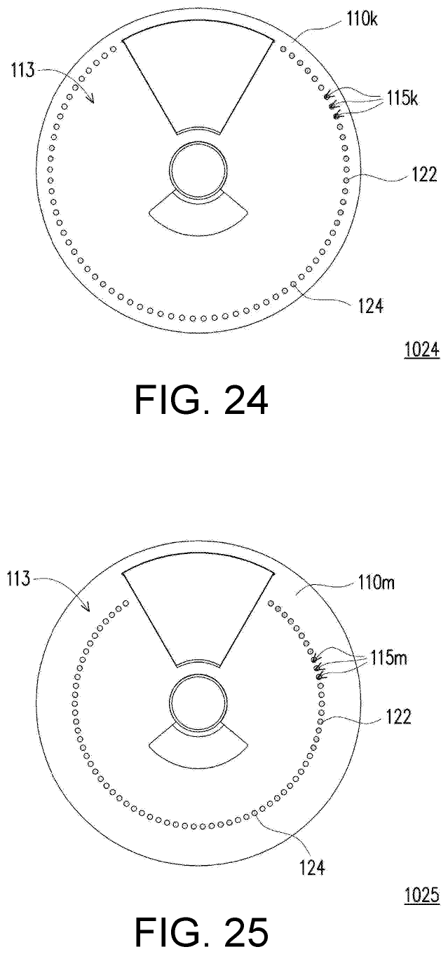

FIG. 24 is a schematic back view of a wavelength conversion module according to an embodiment of the disclosure. Please refer to FIG. 17B and FIG. 24 at the same time. The wavelength conversion module 1024 of this embodiment is similar to the wavelength conversion module 1017 of FIG. 17B. The difference between the two is: the number of through holes 115k of the substrate 110k of this embodiment is multiple, and the shape of each through hole 115k is embodied as a circle, wherein the through holes 115k are separated from each other and arranged as non-continuous outer circular holes along the outer side of the wavelength conversion layers 122 and 124.

FIG. 25 is a schematic back view of a wavelength conversion module according to an embodiment of the disclosure. Please refer to FIG. 17B and FIG. 25 at the same time. The wavelength conversion module 1025 of this embodiment is similar to the wavelength conversion module 1017 of FIG. 17B. The difference between the two is: the number of through holes 115m of the substrate 110m of this embodiment is multiple, and the shape of each through hole 115m is embodied as a circle, wherein the through holes 115m are separated from each other and arranged as non-continuous inner circular holes along the inner side of the wavelength conversion layers 122 and 124.

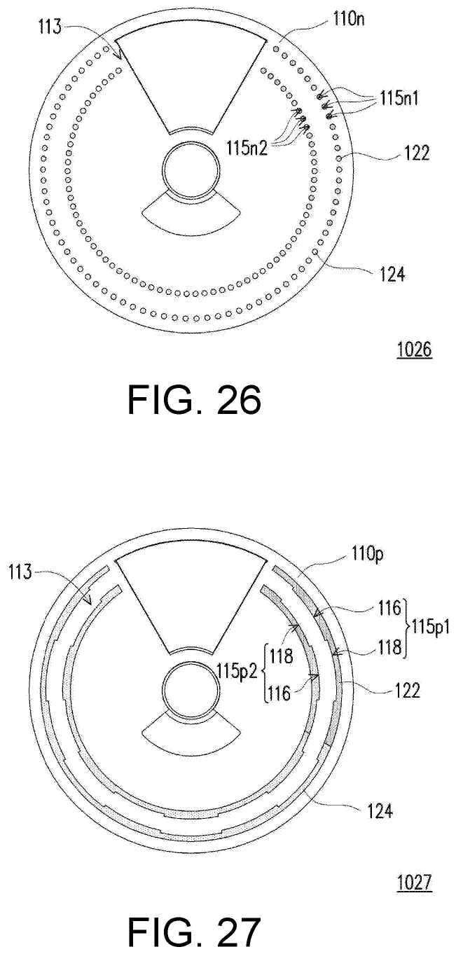

FIG. 26 is a schematic back view of a wavelength conversion module according to an embodiment of the disclosure. Please refer to FIG. 17B and FIG. 26 at the same time. The wavelength conversion module 1026 of this embodiment is similar to the wavelength conversion module 1017 of FIG. 17B. The difference between the two is: the number of through holes 115n1 and 115n2 of the substrate 110n in this embodiment is multiple, and the shape of each through hole 115n1 and 115n2 is embodied as a circle. These through holes 115n1 are separated from each other, and are arranged as non-continuous outer circular holes along the outer side of the wavelength conversion layers 122 and 124 (that is, relatively close to the edge of the substrate 110n). These through holes 115n2 are separated from each other and arranged as non-continuous inner circular holes along the inner side of the wavelength conversion layers 122 and 124 (that is, relatively far away from the edge of the substrate 110n).

FIG. 27 is a schematic back view of a wavelength conversion module according to an embodiment of the disclosure. Please refer to FIG. 20 and FIG. 27 at the same time. The wavelength conversion module 1027 of this embodiment is similar to the wavelength conversion module 1020 of FIG. 20. The difference between the two is: the through holes 115p1 and 115p2 of the substrate 110p of this embodiment are arc shapes with different widths. In detail, the through holes 115p1 and 115p2 respectively have a plurality of convex portions 116 and concave portions 118, wherein the convex portion 116 of the through hole 115p1 corresponds to the concave portion 118 of the through hole 115p2, and the concave portion 118 of the through hole 115p1 corresponds to the convex portion 116 of the through hole 115p2. Here, the through hole 115p1 may be regarded as an exo arc-shaped hole, and the through hole 115p2 may be regarded as an endo arc-shaped hole.

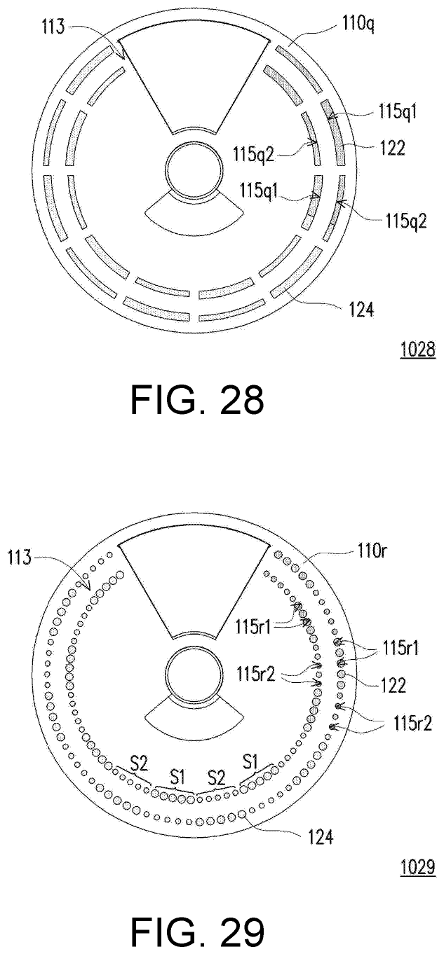

FIG. 28 is a schematic back view of a wavelength conversion module according to an embodiment of the disclosure. Please refer to FIG. 23 and FIG. 28 at the same time. The wavelength conversion module 1028 of this embodiment is similar to the wavelength conversion module 1023 of FIG. 23. The difference between the two is: in this embodiment, the radial width of the through hole 115q1 of the substrate 110q is different from the radial width of the through hole 115q2, the shapes of the through holes 115q1 and 115q2 are all arc shapes. In detail, the radial width of the through hole 115q1 is greater than the radial width of the through hole 115q2, and the through holes 115q1 and 115q2 are separated from each other, and are arranged as non-continuous outer thick-and-thin arc-shaped holes and non-continuous inner thick-and-thin arc-shaped holes along the outer side and inner side of the wavelength conversion layers 122 and 124. Here, in the radial direction, one through hole 115q1 corresponds to one through hole 115q2, wherein the through holes 115q1 and the through holes 115q2 are arranged alternately.

FIG. 29 is a schematic back view of a wavelength conversion module according to an embodiment of the disclosure. Please refer to FIG. 26 and FIG. 29 at the same time. The wavelength conversion module 1029 of this embodiment is similar to the wavelength conversion module 1026 of FIG. 26. The difference between the two is: in this embodiment, the number of through holes 115r1 and 115r2 of the substrate 110r are multiple, and the shape of each through hole 115r1 and 115r2 is embodied as a circle, and the diameter of the through hole 115r1 is greater than the diameter of the through hole 115r2. These through holes 115r1 and 115r2 are separated from each other, and are arranged as non-continuous outer large-and-small circular holes and non-continuous inner large-and-small circular holes along the outer side and inner side of the wavelength conversion layers 122 and 124. Here, in the radial direction, one through hole 115r1 corresponds to one through hole 115r2, wherein the plurality of through holes 115r1 are the first group S1, and the plurality of through holes 115r2 are the second group S2, and the first group S1 and the second group S2 are arranged alternately.

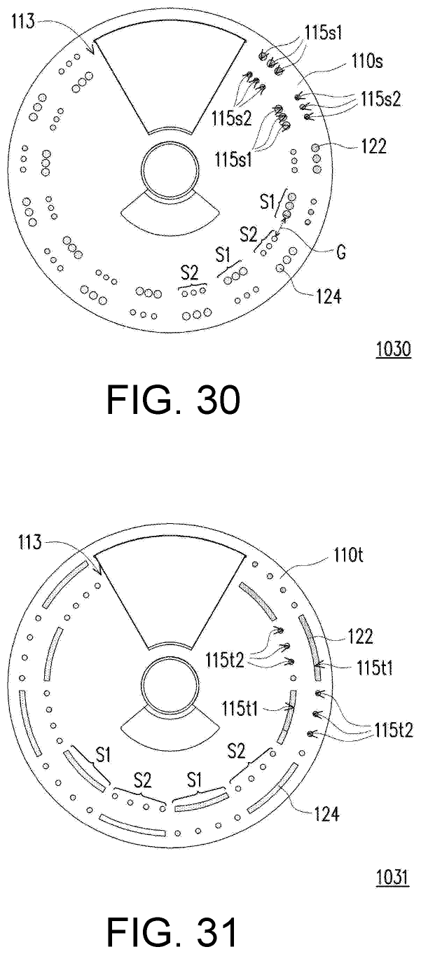

FIG. 30 is a schematic back view of a wavelength conversion module according to an embodiment of the disclosure. Please refer to FIG. 29 and FIG. 30 at the same time. The wavelength conversion module 1030 of this embodiment is similar to the wavelength conversion module 1029 of FIG. 29. The difference between the two is: in this embodiment, the shapes of the through holes 115s1 and 115s2 of the substrate 110s are embodied as circles, and the diameter of the through hole 115s1 is greater than the diameter of the through hole 115s2. Here, in the radial direction, one through hole 115s1 corresponds to one through hole 115s2, wherein the plurality of through holes 115s1 are the first group S1, and the plurality of through holes 115s2 are the second group S2, wherein the first group S1 and the second group S2 are arranged alternately, and there is a separation gap G between the first group S1 and the second group S2.

FIG. 31 is a schematic back view of a wavelength conversion module according to an embodiment of the disclosure. Please refer to FIG. 23 and FIG. 31 at the same time. The wavelength conversion module 1031 of this embodiment is similar to the wavelength conversion module 1023 of FIG. 23. The difference between the two is: in this embodiment, the shape of the through hole 115t1 of the substrate 110t is embodied as an arc shape, and the shape of the through hole 115t2 is embodied as a circle. Here, in the radial direction, one through hole 115t1 corresponds to four through holes 115t2, wherein one of the through holes 115t1 is the first group S1, and the four through holes 115t2 are the second group S2, and the first group S1 and the second group S2 are arranged alternately.

In short, the embodiments of the disclosure provide no limitation to the shape of the through holes 115a, 115b, 115c, 115d, 115e, 115f, 115g1, 115g2, 115h, 115i, 115j1, 115j2, 115k, 115m, 115n1, 115n2, 115p1, 115p2, 115q1, 115q2, 115r1, 115r2, 115s1, 115s2, 115t1, and 115t2, which may be arcs, circles, polygons, or a combination of the foregoing. In addition, the embodiments of the disclosure provide no limitation to the number of the through holes 115a, 115b, 115c, 115d, 115e, 115f, 115g1, 115g2, 115h, 115i, 115j1, 115j2, 115k, 115m, 115n1, 115n2, 115p1, 115p2, 11q1, 115q2, 115r1, 115r2, 115s1, 115s2, 115t1, and 115t2, which may be formed as one or more continuous arc-shaped holes, one or more non-continuous arc-shaped holes formed by multiple arc-shaped through holes, multiple circular holes or a combination of the above.

In summary, the embodiments of the disclosure at least have one of the following advantages or effects. In the design of the wavelength conversion module of the disclosure, since the orthographic projection of the wavelength conversion layer on the substrate overlaps the through holes of the substrate, when the wavelength conversion module is in operation, the gas may form forced convection or natural convection in the through holes of the substrate, so that the circular airflow may be directly blown to the wavelength conversion layer, which facilitates the heat dissipation of the wavelength conversion layer. In short, the wavelength conversion module of the disclosure may have a better heat dissipation effect on the wavelength conversion layer, and a better projection quality and product competitiveness may be achieved by adopting the wavelength conversion module of the disclosure.

The foregoing description of the preferred embodiments of the disclosure has been presented for purposes of illustration and description. It is not intended to be exhaustive or to limit the disclosure to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the disclosure and its best mode practical application, thereby to enable persons skilled in the art to understand the disclosure for various embodiments and with various modifications as are suited to the particular use or implementation contemplated. It is intended that the scope of the disclosure be defined by the claims appended hereto and their equivalents in which all terms are meant in their broadest reasonable sense unless otherwise indicated. Therefore, the term “the disclosure”, “the present disclosure” or the like does not necessarily limit the claim scope to a specific embodiment, and the reference to particularly preferred exemplary embodiments of the disclosure does not imply a limitation on the disclosure, and no such limitation is to be inferred. The disclosure is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the disclosure. It should be appreciated that variations may be made in the embodiments described by persons skilled in the art without departing from the scope of the present disclosure as defined by the following claims. Moreover, no element and component in the present disclosure is intended to be dedicated to the public regardless of whether the element or component is explicitly recited in the following claims.

What is claimed is:

1. A wavelength conversion module, comprising a substrate and a wavelength conversion layer, wherein:
the substrate has a first surface and a second surface opposite to each other, and at least one through hole penetrating the substrate and connecting the first surface and the second surface; and
the wavelength conversion layer is disposed on the first surface of the substrate and covers the at least one through hole, wherein an orthographic projection of the wavelength conversion layer on the substrate overlaps the at least one through hole.

2. The wavelength conversion module according to claim 1, further comprising:
a reflective layer, disposed between the first surface of the substrate and the wavelength conversion layer, wherein the orthographic projection of the wavelength conversion layer on the substrate completely overlaps an orthographic projection of the reflective layer on the substrate, and an orthographic projection area of the wavelength conversion layer on the substrate is equal to an orthographic projection area of the reflective layer on the substrate.

3. The wavelength conversion module according to claim 2, wherein the at least one through hole comprises at least one blind via and a plurality of micropores, the at least one blind via extends from the second surface to a direction of the first surface, and the micropores extend from the first surface to a direction of the second surface, and a depth of the micropores at least accounts for 30% of a thickness of the substrate.

4. The wavelength conversion module according to claim 2, further comprising:
a thermally conductive material filled in the at least one through hole, wherein the thermally conductive material directly contacts the reflective layer, and a thermal conductivity of the thermally conductive material is greater than a thermal conductivity of the substrate, and a thickness of the thermally conductive material at least accounts for 20% of a thickness of the substrate.

5. The wavelength conversion module according to claim 1, further comprising:
an adhesive layer, which is disposed between the first surface of the substrate and the wavelength conversion layer, and the adhesive layer extends to cover a peripheral surface of the wavelength conversion layer, wherein the adhesive layer has at least one opening, and the at least one opening communicates with the at least one through hole.

6. The wavelength conversion module according to claim 5, wherein the at least one through hole comprises at least one blind via and a plurality of micropores, the at least one blind via extends from the second surface to a direction of the first surface, the micropores extend from the first surface to a direction of the second surface, and a depth of the micropores at least accounts for 30% of a thickness of the substrate.

7. The wavelength conversion module according to claim 5, further comprising:
a thermally conductive material filled up in the at least one opening of the adhesive layer and filled in the at least one through hole, wherein the thermally conductive material directly contacts the wavelength conversion layer, and a thermal conductivity of the thermally conductive material is greater than a thermal conductivity of the substrate, and a thickness of the thermally conductive material in the at least one through hole at least accounts for 20% of a thickness of the substrate.

8. The wavelength conversion module according to claim 7, wherein the thermally conductive material is filled up in the at least one through hole, and the thermally conductive material is aligned with the second surface of the substrate.

9. The wavelength conversion module according to claim 5, further comprising:
a reflective layer, disposed between the wavelength conversion layer and a portion of the adhesive layer, wherein the orthographic projection of the wavelength conversion layer on the substrate completely overlaps an orthographic projection of the reflective layer on the substrate, and an orthographic projection area of the wavelength conversion layer on the substrate is greater than an orthographic projection area of the reflective layer on the substrate.

10. The wavelength conversion module according to claim 9, wherein the at least one opening exposes a surface of the reflective layer relatively far away from the wavelength conversion layer.

11. The wavelength conversion module according to claim 10, wherein the at least one through hole comprises at least one blind via and a plurality of micropores, the at least one blind via extends from the second surface to a direction of the first surface, and the micropores extend from the first surface to a direction of the second surface, and a depth of the micropores at least accounts for 30% of a thickness of the substrate.

12. The wavelength conversion module according to claim 9, wherein the at least one through hole comprises at least one blind via and a plurality of micropores, the at least one blind via extends from the second surface to a direction of the first surface, and the micropores extend from the first surface to a direction of the second surface, and a depth of the micropores at least accounts for 30% of a thickness of the substrate.

13. The wavelength conversion module according to claim 9, further comprising:
a thermally conductive material filled up in the at least one opening of the adhesive layer and filled in the at least one through hole, wherein the thermally conductive material directly contacts the wavelength conversion layer, and a thermal conductivity of the thermally conductive material is greater than a thermal conductivity of the substrate, and a thickness of the thermally conductive material in the at least one through hole at least accounts for 20% of a thickness of the substrate.

14. The wavelength conversion module according to claim 1, further comprising:
a reflective layer, disposed between the first surface of the substrate and the wavelength conversion layer, wherein the orthographic projection of the wavelength conversion layer on the substrate completely overlaps an orthographic projection of the reflective layer on the substrate, and an orthographic projection area of the wavelength conversion layer on the substrate is equal to an orthographic projection area of the reflective layer on the substrate; and
an adhesive layer, which is disposed between the first surface of the substrate and the reflective layer, and the adhesive layer extends to cover a peripheral surface of the reflective layer, wherein the adhesive layer has at least one opening, and the at least one opening communicates with the at least one through hole.

15. The wavelength conversion module according to claim 14, wherein the at least one through hole comprises at least one blind via and a plurality of micropores, the at least one blind via extends from the second surface to a direction of the first surface, the micropores extend from the first surface to a direction of the second surface, and a depth of the micropores at least accounts for 30% of a thickness of the substrate.

16. The wavelength conversion module according to claim 14, further comprising:
a thermally conductive material filled up in the at least one opening of the adhesive layer and filled in the at least one through hole, wherein the thermally conductive material directly contacts the reflective layer, and a thermal conductivity of the thermally conductive material is greater than a thermal conductivity of the substrate, and a thickness of the thermally conductive material in the at least one through hole at least accounts for 20% of a thickness of the substrate.

17. The wavelength conversion module according to claim 1, wherein an orthographic projection area of the at least one through hole on the wavelength conversion layer accounts for 2% to 20% of an area of the wavelength conversion layer.

18. The wavelength conversion module according to claim 1, wherein a maximum width of the at least one through hole is smaller than a radial width of the wavelength conversion layer, and the maximum width is between 0.1 mm and 5.5 mm.

19. The wavelength conversion module according to claim 1, wherein the number of the at least one through hole is one, and a shape of the through hole comprises an arc shape.

20. The wavelength conversion module according to claim 1, wherein the number of the at least one through hole is multiple, and a shape of the plurality of through holes comprises an arc shape, a circle, a polygon, or a combination thereof.

21. A projector, comprising a light-emitting unit, a wavelength conversion module, a light valve, and a projection lens, wherein:
the light-emitting unit is configured to emit an illumination beam;
the wavelength conversion module is disposed on a transmission path of the illumination beam, and the wavelength conversion module comprises a substrate and a wavelength conversion layer, wherein:
the substrate has a first surface and a second surface opposite to each other, and at least one through hole penetrating the substrate and connecting the first surface and the second surface; and
the wavelength conversion layer is disposed on the first surface of the substrate and covers the at least one through hole, wherein an orthographic projection of the wavelength conversion layer on the substrate overlaps the at least one through hole;
the light valve is disposed on the transmission path of the illumination beam and is configured to convert the illumination beam into an image beam; and
the projection lens is disposed on an transmission path of the image beam and configured to convert the image beam into a projection beam.
